(19) United States
(12) Patent Application Publication
(10) Pub. No.: US 2022/0344658 A1
(43) Pub. Date: Oct. 27, 2022

(54) NOVEL LITHIUM-METAL OXIDE COMPOSITE, AND LITHIUM SECONDARY BATTERY COMPRISING SAME

(71) Applicant: L&F CO., LTD., Daegu (KR)

(72) Inventors: Sang Hoon JEON, Daegu (KR); Sung Kyun CHANG, Daegu (KR); Ji Hyun SHIN, Daegu (KR); Sun Hye LIM, Daegu (KR); Doe Hyoung KIM, Daegu (KR)

(21) Appl. No.: 17/765,963

(22) PCT Filed: Oct. 1, 2019
(86) PCT No.: PCT/KR2019/012783

§ 371 Date: May 19, 2022

(51) Int. Cl. H01M 4/525; H01M 10/0525; H01M 4/505; H01M 4/38; H01M 10/44

(52) U.S. Cl. CPC H01M 4/525; H01M 10/0525; H01M 4/505; H01M 4/386; H01M 10/44

(57) ABSTRACT

Disclosed is a lithium composite metal oxide containing nickel (Ni) and titanium (Ti) as main components. The lithium composite metal oxide, which is a cathode active material for a lithium secondary battery, has high charge capacity and desirable lifespan characteristics, and realizes optimal performance of a lithium secondary battery when used in combination with an anode active material having high energy density. In particular, the lithium composite metal oxide is capable of maintaining optimal balance with the charge and discharge efficiency of the Si-based anode active material and thus enables manufacture of a high-performance lithium secondary battery.

### TECHNICAL FIELD

The present invention relates to a novel lithium composite metal oxide containing nickel (Ni) and titanium (Ti) as main components and a lithium secondary battery containing the same.

### BACKGROUND ART

Lithium secondary batteries have high charge/discharge capacity, high operating potential and energy density, and excellent charge and discharge cycle characteristics, and the application fields thereof are rapidly expanding to portable electronic devices as well as small electronic devices for domestic use, motorcycles, electric vehicles, hybrid vehicles, and the like based thereon.

In recent years, as portable electronic devices are popularized and the demand for application to medium- and large-sized devices is rapidly increasing, a secondary battery having higher capacity for a given volume has come to be required, and research on the main components of lithium secondary batteries is actively being conducted for this purpose.

As is well known, as a cathode active material, which is one of the core components of lithium secondary batteries, an LCO (LiCoO₂)-based cathode active material having a higher capacity per unit volume has been developed, but has not been commercialized due to safety issues such as the combustibility thereof. In an attempt to solve this problem, NCA containing Ni and Co as main components and a small amount of Al has been developed, and NCM (Ni—Co—Mn), having superior stability to NCA, has been developed.

NCA exhibits superior capacity and output, but is relatively unsafe compared to NCM. For this reason, NCMs containing Ni, Co, and Mn as main components are most commonly used. The NCM-based cathode active material generally has a charge capacity of 185 to 192 mAh/g and a discharge capacity of 167 to 173 mAh/g.

Recently, the demand for high-capacity lithium secondary batteries has been continuously increasing. In conventional lithium secondary batteries, when the capacity increases, the lifespan greatly decreases. When the lifespan is enhanced through doping, coating, or the like to solve this problem, the problem whereby the capacity is greatly reduced again remains unsolved.

An anode active material, which is one of the core components of a lithium secondary battery, is also being actively researched in order to improve the characteristics thereof. In particular, in order to secure a higher capacity per unit volume, research is underway on novel materials to replace conventional graphite-based materials.

For example, a Si-based anode active material has a very high energy density and thus is in the spotlight as a novel anode material. While a conventional graphite-based anode active material has a theoretical capacity of about 370 mAh/g, a Si-based anode active material has a theoretical capacity of about 4,200 mAh/g, which is at least ten times higher than that of the conventional graphite-based anode active material, and has the advantages of a small potential difference from lithium and abundant reserves.

However, it is known that such a Si-based anode active material exhibits a charge/discharge efficiency of about 70 to 88%, which is very different from the charge/discharge efficiency of about 90 to 92% of a commercially available NCM-based cathode active material.

In addition, in general, upon evaluation of the characteristics of an NCM-based cathode active material, it is important to consider the discharge capacity rather than the charge capacity. However, charge capacity is more important than discharge capacity from the viewpoint of energy density.

For this reason, although the energy density of the anode active material is improved, if the charge capacity of the cathode active material is small or the charge/discharge efficiency between the cathode and the anode is out of balance, the overall characteristics of the cell may not be optimized. Inferior lifespan characteristics cause a problem in that, although cells can be researched, they cannot be actually commercialized and cannot contribute to industrial development.

Therefore, there is urgent need for the development of a novel cathode active material that can solve these problems.

### DISCLOSURE

### Technical Problem

Therefore, the present invention has been made to solve the above and other technical problems that have yet to be solved.

Therefore, as a result of extensive research and various experiment, the present inventors developed a novel lithium composite metal oxide containing nickel and titanium as main components and found that a cathode active material containing the lithium composite metal oxide has high charge capacity and lifespan characteristics and also can exhibits optimal performance for a lithium secondary battery when used in combination with a Si-based anode active material that has high energy density but somewhat low charge and discharge efficiency. The present invention was completed based thereon.

### Technical Solution

For better understanding of the present invention, the difference due to the imbalance in charge/discharge efficiency between the cathode active material and the anode active material will be briefly described.

In general, graphite-based anode active materials are most often used in the manufacture of lithium secondary batteries. The charge/discharge efficiency of a graphite-based anode active material is about 93%, whereas the charge/discharge efficiency of a Si-based anode active material is about 70 to 88%. Thus, there is a large difference therebetween.

When a lithium secondary battery is manufactured using a cathode active material having a charge/discharge efficiency of 90% and a graphite anode active material having a charge/discharge efficiency of 93%, the cathode can send 100 Li atoms to the anode and receive up to 90 Li atoms therefrom, whereas the graphite-based cathode can receive 100 Li atoms and then send up to 93 Li atoms to the anode. In other words, although the anode sends 93 Li atoms, the cathode can receive only up to 90 Li atoms therefrom, so 3 Li atoms are not used and are wasted. Therefore, various studies are being conducted to improve the discharge capacity and charge/discharge efficiency of the cathode active material.

However, when a lithium secondary battery is manufactured using a cathode active material having a charge/discharge efficiency of 91% and a Si-based anode active material having a charge/discharge efficiency of 88%, the cathode can send 100 Li atoms to the anode and then receive up to 91 Li atoms therefrom, whereas the Si-based cathode can receive 100 Li atoms therefrom and send up to 88 Li atoms thereto. That is, the cathode can receive up to 91 Li atoms, but the anode can only send up to 88 Li atoms, so spare capacity corresponding to 3 Li atoms is not used, and is wasted.

For this reason, no matter how high the discharge capacity and charge/discharge efficiency of the cathode active material, the active material is useless and is wasted when used in combination with a Si-based anode material having low charge/discharge efficiency.

This means that a cathode active material that has high charge capacity so as to send more Li atoms to the anode, having high energy density, and charge/discharge efficiency that is in balance with that of a Si-based anode active material, rather than a cathode active material having very high discharge capacity and very high charge/discharge efficiency is required in order to use a Si-based anode active material having high energy density.

The present applicant has completed the present invention based on this technical point of view and secured high charge capacity and lifespan characteristics through a novel lithium composite metal oxide containing nickel (Ni) and titanium (Ti) as main components.

This lithium composite metal oxide according to the present invention simultaneously satisfies at least two characteristics among the following characteristics, measured based on a coin half cell, or preferably satisfies all three characteristics.

a characteristic of a charge capacity of 235 mAh/g or more under the conditions of 0.1 C 4.3V (charge) and 0.1 C 3.0V (discharge);

a characteristic of a charge/discharge efficiency of 90% or less under the conditions of 0.1 C 4.3V (charge) and 0.1 C 3.0V (discharge); and

a characteristic of a retention rate of a discharge capacity at a 30^{th} cycle with respect to a discharge capacity at a 1^{st} cycle under conditions of 1.0 C 4.3V (charge) and 1.0 C 3.0V (discharge).

A lithium secondary battery having a charge capacity of 235 mAh/g or more is suitable for use as a high-capacity lithium secondary battery, and preferably has a charge/discharge efficiency of 90% or less, more preferably 88% or less, to realize a balance with a Si-based anode. In addition, it is preferable that the discharge capacity retention rate enabling the lifespan characteristics be 90% or more, and it is most preferable to satisfy all three characteristics. However, even if two or more are satisfied, it is suitable for use in combination with a Si-based anode active material.

In addition to this, the lithium composite metal oxide according to the present invention simultaneously satisfies at least two characteristics among the following characteristics measured based on a pouch full cell to which a Si-based anode is applied, or preferably all three characteristics. A silicon/graphite (ratio of 20:80) anode active material was used as a Si-based anode, and the anode/cathode capacity ratio (N/P) was set to 1.1.

a characteristic of a charge capacity of 235 mAh/g or more under the conditions of 0.1 C 4.3V (charge) and 0.1 C 3.0V (discharge);

a characteristic of a discharge capacity of 177 mAh/g or more under the conditions of 0.1 C 4.3V (charge) and 0.1 C 3.0V (discharge); and

a characteristic of a retention rate of a discharge capacity at a 30^{th} cycle with respect to a discharge capacity at a 1^{st} cycle, of 93% or more under the conditions of 1.0 C 4.3V (charge) and 1.0 C 3.0V (discharge).

In the above, the charge capacity and charge/discharge efficiency, measured under the conditions of 0.1 C 4.3V (charge) and 0.1 C 3.0V (discharge), are results obtained by performing charging and discharging at 25° C., and the discharge capacity retention rate, measured under the conditions of 1.0 C 4.3V (charge) and 1.0 C 3.0V (discharge), is a result obtained by performing charging and discharging at 45° C.

These specific characteristics are particularly advantageous when the lithium composite metal oxide constitutes a cathode active material in a lithium secondary battery using an anode active material having a high energy density and relatively low charge/discharge efficiency, such as a Si-based anode active material. This will be described in more detail below from a detailed technical point of view.

Conventional research has focused on improving the characteristics of the cathode active material itself without considering the characteristics of the anode, and thus there has been development toward improvement in the discharge capacity and charge/discharge efficiency. For this reason, when an anode having high energy density, such as a Si-based anode active material, is used, the charge/discharge efficiency of the cathode active material is much higher than that of the anode, which fails to achieve the balance therebetween and the anode active material does not perform the function thereof due to the low charge capacity of the cathode active material.

That is, a conventional cathode active material exhibits high charge/discharge efficiency due to the small difference between charge capacity and discharge capacity, but is incapable of supplying a large amount of Li ions to the anode active material side during charging and is also incapable of receiving a large amount of Li ions from the anode active material during discharging due to the low charge capacity and a great difference in charge and discharge efficiency from the anode.

For example, an NCM-based cathode active material having a charge capacity of 230.1 mAh/g and a discharge capacity of 206 mAh/g has charge/discharge efficiency of about 90%, and the lithium composite metal oxide used as a cathode active material in the present invention and having a charge capacity of 249.88 mAh/g and a discharge capacity of 218 mAh/g has charge/discharge efficiency of 87.24%. In view only of charge and discharge efficiency, an NCM-based cathode active material is better than the lithium composite metal oxide of the present invention. However, when used in combination with the Si-based anode active material for a lithium secondary battery, the performance of the secondary battery to which the lithium composite metal oxide according to the present invention is applied is greatly superior to that of the secondary battery to which a conventional NCM-based cathode active material is applied, which can be observed in the experimental results to be described later.

An Ni-rich or high-Ni cathode active material having a very high Ni content exhibits higher charge capacity and discharge capacity than a general NCM-based cathode active material, but has a problem of seriously deteriorated lifespan characteristics. In an attempt to solve this problem, doping or coating is used. However, this causes a problem in that charge capacity and discharge capacity are greatly reduced, instead of slightly improving lifespan characteristics, so it is very difficult to commercialize a product based thereon. In addition to this, such a material has high charge and discharge efficiency and thus is not in balance with an anode having high energy density, such as a Si-based anode active material, and is not suitable as a next-generation secondary battery.

Considering this point, it is very important to balance the cathode active material with the anode active material in order to realize optimal overall performance of the cell of the lithium secondary battery. In particular, when an anode active material having a very high energy density such as a Si-based material is used, it is more important to improve the charge capacity of the cathode active material than the discharge capacity thereof, and it is very important to impart similar charge and discharge efficiencies to the cathode active material and the anode active material in order to balance the cathode active material and the anode active material.

In other words, a cathode active material having high charge capacity and excellent lifespan characteristics is required in order to maximize the performance of a lithium secondary battery, and furthermore, it should be able to have charge and discharge efficiency similar or equivalent to the anode active material to strike a balance when used in combination with an anode active material having a high energy density, such as a Si-based anode active material.

In this regard, among the characteristics measured based on a coin half cell and a pouch full cell to which a Si-based anode is applied, a cathode active material that simultaneously satisfies at least two characteristics for each criterion, and furthermore, a cathode active material satisfying all three characteristics, has not yet been developed.

On the other hand, the lithium composite metal oxide of the present invention satisfies at least two characteristics, preferably three characteristics, for each criterion among the characteristics defined above when used as a cathode active material.

In this regard, the inventors of the present application prepared a lithium composite metal oxide containing nickel (Ni) and titanium (Ti) as main components instead of Co and Mn of a conventional NCM-based cathode active material so as to satisfy the above characteristics.

First, a cation having a small size should be selected in order for the cation of the cathode active material to have a wide and reversible oxidation/reduction potential region within the structure and to perform rapid charge/discharge or minimize the change in the crystal structure of the cathode active material.

It is known that the ionic radius of Ni³⁺ is 0.56 Å, the ionic radius of Co³⁺ is 0.55 Å, the ionic radius of Mn³⁺ is 0.58 Å, and the ionic radius of Mn⁴⁺ is 0.53 Å, and the ionic radius of Ti⁴⁺ and Al³⁺ are known to be 0.61 Å and 0.54 Å, respectively, which are similar to those of Co³⁺ and Mn³⁺, so the formation of a layered structure is performed to avoid the effect of the ionic radius.

Ti has an electron configuration of [Ar]3d²4 s² and is a 3d transition metal, and thus has a higher electrode potential compared to 4d and 5d transition metals, is relatively light, and is small in size, which is advantageous in terms of capacity per unit weight or unit volume.

In LiNiO₂, which is a Ni-rich cathode active material, the oxidation number of Ni ions is Ni³⁺, and the low spin electron configuration of Ni³⁺ is d⁷, in which electrons exist at a high energy level. When electrons exist at a high energy level, Jahn-Teller distortion occurs. The electron configuration of Ni⁴⁺ is d⁶, in which electrons are not arranged at a high energy level, so Jahn-Teller distortion does not occur. Ni³⁺ and Ni⁴⁺ have different Ni—O bond lengths. For this reason, during the course of charging and discharging, the Ni—O bond repeatedly contracts and expands, thus applying severe stress to the layered structure. In addition, because contact with the conductive material is reduced due to repeated expansion and contraction along the z-axis during charging and discharging, the electrical conductivity of the electrode is lowered, and thus the electrode characteristics are deteriorated. The electron configuration of Ti³⁺ is d⁷ and that of Ti⁴⁺ is d⁰, so it was expected that it would be possible to improve structural stability by substituting some Ni with Ti.

Another consideration is cation mixing, which is a factor that makes the structure of the Ni-rich cathode active material unstable. Cation mixing refers to a phenomenon in which Li⁺(0.76 Å) and Ni²⁺ (0.69 Å), having similar ionic radii, change positions with each other to form a crystal. When Li⁺ is intercalated and deintercalated, Ni²⁺ present in the space layer of Li⁺ acts as a resistive component and reduces charge/discharge efficiency.

The inventors of the present application considered a method of suppressing cation mixing by incorporating Ti as one of the main components in the lithium composite metal oxide. That is, it was expected that Ti⁴⁺ (0.61 Å), having a size similar to that of Ni²⁺ (0.69 Å), is stably located in the tetrahedral site (T_{d}), which is the middle point of the path of Ni ions, to suppress Ni migration, thereby minimizing cation mixing. As a result, a Ni-rich compound having a stable structure was prepared, and the electrochemical properties were improved.

In addition, through a number of experiments, the present applicant found that manganese (Mn), which was used as a main component in a conventional NCM-based cathode active material, has the disadvantage of reducing the charge capacity while improving the lifespan characteristics, whereas titanium (Ti) has an effect of remarkably improving the lifespan characteristics while maintaining the capacity almost the same. In particular, Ti slightly reduces the discharge capacity and thus rather lowers the charge/discharge efficiency of the cathode active material to a level similar to that of a high energy density anode active material such as a Si-based anode active material, which is very desirable for application to next-generation lithium secondary batteries.

A lithium composite metal oxide containing nickel and titanium as main components was developed based thereon, and this lithium composite metal oxide was found to satisfy at least two, preferably three characteristics for each criterion among the characteristics measured based on the coin half cell and the pouch full cell to which the Si-based anode is applied, as defined above, when used as a cathode active material.

In order to satisfy these characteristics, the lithium composite metal oxide of the present invention may contain 82% or more of nickel and 0.5% or more of titanium on a molar basis.

In some cases, when the lithium composite metal oxide optionally further includes one or more of cobalt (Co) and manganese (Mn), the total content of cobalt and manganese is preferably less than or equal to the content of titanium (Ti).

As a result, the lithium composite metal oxide of the present invention enables control of the charge capacity, the discharge capacity, and the charge/discharge efficiency as a cathode active material by adjusting the content of each of Ni and Ti. In addition, when the Ni content increases, the charge capacity increases, but a problem of greatly deteriorated lifespan characteristics due to structural instability occurs. This problem can be solved using Ti.

In a specific example, the lithium composite metal oxide may be a compound represented by the following Formula 1:

Li[Li₁₋ₘXₘ]O₂ (1)

wherein

m satisfies 0<m≤1, and

X contains only Ni and Ti, and may contain other unavoidable impurities.

m may satisfy 0.9≤m≤1 or 0.94≤m≤1.

In a more specific example, the lithium composite metal oxide may be a compound represented by the following Formula 2:

Li[Li_{1-a-b}NiₐTi_{b}]O₂ (2)

wherein

a and b satisfy 0<a<1, 0<b<1, a+b≤1 and a>b.

In Formula 2, a and b satisfy 0.82≤a<1, and 0<b≤0.18, or 0.9≤a<1 and 0<b≤0.1, or 0.94≤a<1 and 0<b≤0.06.

In another specific example, the lithium composite metal oxide of the present invention may further contain aluminum (Al). In this regard, the inventors of the present application have additionally selected Al as an element that can be used in combination with Ti to greatly improve the cation mixing inhibitory effect and thermal stability.

Al³⁺ has a bonding strength with oxygen (Al—O) of 502 kJ/mol, which is larger than Ni—O (366 kJ/mol), Co—O (385 kJ/mol), and Mn—O (362 kJ/mol), and has an ionic radius similar to Ni³⁺, Co³⁺, or Mn⁴⁺, and is thus suitable as a substitution element, and is more effective in suppressing cation mixing by reducing Vo (oxygen vacancy), which is one of the movement paths of Ni ions. In particular, when Al is added, the occurrence of irreversible phase transition is suppressed, so structural stability is improved and thus lifespan characteristics are improved.

As a result, Al may be added as another main component to improve the lifetime characteristics while suppressing cation mixing.

In a specific example, the lithium composite metal oxide of the present invention may be a compound represented by the following Formula (3):

Li[Li_{1-a-b-c}NiₐTi_{b}Al_{c}]O₂ (3)

wherein

a, b and c satisfy 0<a<1, 0<b<1, 0<c<1, with the proviso that a+b+c≤1, and

a, b and c satisfy the condition a>b≥c or a>c>b.

In Formula 3, a, b, and c satisfy 0.82≤a<1, 0<b<0.18, and 0<c<0.18, or 0.9≤a<1, 0<b<0.1, and 0<c<0.1, or 0.94≤a<1, 0<b<0.06, and 0<c<0.06.

In another specific example, the lithium composite metal oxide of the present invention may further contain at least one of other dopant (D) elements and optionally aluminum (Al) in order to further improve the properties as a cathode active material, and may be a compound represented by the following Formula 4.

Such a dopant (D) is, for example, selected from Co, Mn, V, Cr, Fe, Cu, Zn, Y, Zr, Mo, W, Na, K, Rb, Cs, Fr, Be, Mg, Ca, Sr, Ba, Ra, B, Si, P, Sn, La, Ce, and the like. In addition, in the lithium composite metal oxide of the present invention, the tetracoordinate element and the hexacoordinate element are easily substituted with each other, so the dopant (D) may preferably be at least one selected from tetracoordinate and hexacoordinate elements.

Li[Li_{1-a-b-c-d}NiₐTi_{b}Al_{c}D_{d}]O₂ (4)

wherein

D includes at least one selected from the group consisting of Co, Mn, V, Cr, Fe, Cu, Zn, Y, Zr, Mo, W, Na, K, Rb, Cs, Fr, Be, Mg, Ca, Sr, Ba, Ra, B, Si, P, Sn, La and Ce,

a, b, c, and d satisfy 0<a<1, 0<b<1, 0≤c<1, 0≤d<1, and a+b+c+d≤1, and

a, b, c, and d satisfy the condition a>b≥c+d or a>c+d>b.

In Formula 4, a, b and c satisfy 0.82≤a<1, 0<b≤0.18, and 0≤c+d<0.18, or 0.9≤a<1, 0<b≤0.1, and 0≤c+d<0.1, or 0.94≤a<1, 0≤b≤0.06, and 0≤c+d<0.06. In addition, the present invention contains titanium as a main component and thus a, b and c preferably satisfy b≥c or b≥c+d.

In the lithium composite metal oxide of the present invention described above, each element may be uniformly distributed with respect to oxide particles, and some component(s) may be distributed with a concentration gradient with respect to the remaining component(s). Such a concentration gradient may exhibit a sharp concentration change or a broad concentration change.

For example, in Formula 4, at least one of Li, Ni, Ti, Al, and D may have a concentration gradient that increases or decreases as a function of the radius of the oxide particle.

The present invention also provides a cathode active material for a lithium secondary battery containing the lithium composite metal oxide, and a lithium secondary battery including a cathode containing the cathode active material, an anode and an electrolyte.

The cathode active material of the present invention may be composed of only lithium composite metal oxide, or may be composed of a combination of the lithium composite metal oxide with various conventionally known lithium transition metal oxides. In addition, a known coating layer may be further added to the surface of the lithium composite metal oxide in the cathode active material of the present invention to improve physical properties. All of these examples fall within the scope of the present invention.

The anode active material constituting the anode may, for example, be a lithium (Li)-based, graphite-based, tin (Sn)-based, or silicon (Si)-based anode active material or the like, and may preferably contain a Si-based silicon/graphite (at a ratio of 20:80) anode active material for the same reason as described above.

Examples of such a Si-based anode active material include silicon (Si), silicon oxide, Si/A alloys such as Si/Li and Si/Sn, and Si/C composites such as SiO—C. The silicon oxide is, for example, SiOₓ (0<x<2), and A in the Si/A alloy may be an alkali metal, an alkaline earth metal, a group 13 to 16 element, a transition metal, or a rare earth element such as Li, Sn, Mg, Ca, Sr, Ba, Ra, Sc, Y, Ti, Zr, Hf, Rf, V, Nb, Ta, db, Cr, Mo, W, Sg, Tc, Re, Bh, Fe, Pb, Ru, Os, Hs, Rh, Ir, Pd, Pt, Cu, Ag, Au, Zn, Cd, B, Al, Ga, In, Ti, Ge, P, As, Sb, Bi, S, Se, Te, or Po, or a combination thereof.

These may be used alone or may be used in combination of two or more. In addition, these may be used in combination with a lithium-based, graphite-based, or tin-based anode active material.

Other features constituting the lithium secondary battery are known in the art, and thus a description thereof will be omitted herein.

### Effects of the Invention

As described above, the lithium composite metal oxide according to the present invention, which is a cathode active material for a lithium secondary battery, has high charge capacity and desirable lifespan characteristics, and realizes optimal performance of a lithium secondary battery when used in combination with an anode active material having high energy density. In particular, the lithium composite metal oxide is capable of maintaining optimal balance with the charge and discharge efficiency of the Si-based anode active material and thus enables manufacture of a high-performance lithium secondary battery.

### BEST MODE

Now, the present invention will be described in more detail with reference to the following examples. These examples should not be construed as limiting the scope of the present invention.

### [Comparative Example 1]—Ni_{0.82}Co_{0.11}Mn_{0.07}

NiSO₄ as a nickel precursor, CoSO₄ as a cobalt precursor, and MnSO₄ as a manganese precursor were added to water at a molar ratio of 82:11:7 to prepare an aqueous solution of a nickel-cobalt-manganese hydroxide precursor. An aqueous solution of sodium hydroxide was slowly added dropwise while the aqueous precursor solution was stirred to neutralize the aqueous precursor solution to thereby precipitate Ni_{0.82}Co_{0.11}Mn_{0.07}(OH)₂ as nickel-cobalt-manganese hydroxide. LiOH was mixed with the precursor thus obtained with at a molar ratio of 1.02, followed by calcination in an oxygen atmosphere at 785° C. for 30 hours to prepare a cathode active material.

### [Example 1-1]—Ni_{0.94}Ti_{0.06}

\textcircled{1} NiSO₄ as a nickel precursor and TiSO₄ as a titanium precursor were added to water at a molar ratio of 94:06 to prepare an aqueous solution of a nickel-titanium hydroxide precursor. An aqueous solution of sodium hydroxide was slowly added dropwise while the aqueous precursor solution was stirred to neutralize the aqueous precursor solution to thereby precipitate Ni_{0.94}Ti_{0.06}(OH)₂ as nickel-titanium hydroxide. LiOH was mixed with the precursor thus obtained with the precursor thus obtained at a molar ratio of 1.02, followed by calcination in an oxygen atmosphere at 755° C. for 30 hours.

\textcircled{2} NiSO₄ as a nickel precursor and TiSO₄ as a titanium precursor were added to water at a molar ratio of 98:02 to prepare an aqueous solution of a nickel-titanium hydroxide precursor. An aqueous solution of sodium hydroxide was slowly added dropwise while the aqueous precursor solution was stirred to neutralize the aqueous precursor solution to thereby precipitate Ni_{0.98}Ti_{0.02}(OH)₂ as nickel-titanium hydroxide. LiOH was mixed with the precursor thus obtained at a molar ratio of 1.02, and TiO₂ was further added at a molar ratio of 0.04, followed by calcination in an oxygen atmosphere at 740° C. for 30 hours.

### [Example 1-2]—Ni_{0.94}Ti_{0.04}Al_{0.02}

\textcircled{1} NiSO₄ as a nickel precursor, TiSO₄ as a titanium precursor, and Al₂(SO₄)₃ as an aluminum precursor were added to water at a molar ratio of 94:4:2 to prepare an aqueous solution of a nickel-titanium-aluminum hydroxide precursor. An aqueous solution of sodium hydroxide was slowly added dropwise while the aqueous precursor solution was stirred to neutralize the aqueous precursor solution to thereby precipitate Ni_{0.94}Ti_{0.04}Al_{0.02}(OH)₂ as nickel-titanium-aluminum hydroxide. LiOH was mixed with the precursor thus obtained at a molar ratio of 1.02, followed by calcination in an oxygen atmosphere at 740° C. for 30 hours.

\textcircled{2} NiSO₄ as a nickel precursor, TiSO₄ as a titanium precursor, and Al₂(SO₄)₃ as an aluminum precursor were added to water at a molar ratio of 96:2:2 to prepare an aqueous solution of a nickel-titanium-aluminum hydroxide precursor. An aqueous solution of sodium hydroxide was slowly added dropwise thereto while the aqueous precursor solution was stirred to neutralize the aqueous precursor solution to thereby precipitate Ni_{0.96}Ti_{0.02}Al_{0.02}(OH)₂ as nickel-titanium-aluminum hydroxide. LiOH was mixed with the precursor thus obtained at a molar ratio of 1.02, and TiO₂ was further added at a molar ratio of 0.02, followed by calcination in an oxygen atmosphere at 740° C. for 30 hours.

### [Example 2-1]—Ni_{0.98}Ti_{0.02}

NiSO₄ as a nickel precursor and TiSO₄ as a titanium precursor were added to water at a molar ratio of 98:2 to prepare an aqueous solution of a nickel-titanium hydroxide precursor. An aqueous solution of sodium hydroxide was slowly added dropwise thereto while the aqueous precursor solution was stirred to neutralize the aqueous precursor solution to thereby precipitate Ni_{0.95}Ti_{0.02}(OH)₂ as nickel-titanium hydroxide. LiOH was mixed with the precursor thus obtained at a molar ratio of 1.02, followed by calcination in an oxygen atmosphere at 730° C. for 30 hours.

### [Example 2-2]—Ni_{0.98}Ti_{0.01}Al_{0.01}

\textcircled{1} NiSO₄ as a nickel precursor, TiSO₄ as a titanium precursor, and Al₂(SO₄)₃ as an aluminum precursor were added to water at a molar ratio of 98:1:1 to prepare an aqueous solution of a nickel-titanium-aluminum hydroxide precursor. An aqueous solution of sodium hydroxide was slowly added dropwise thereto while the aqueous precursor solution was stirred to neutralize the aqueous precursor solution to thereby precipitate Ni_{0.98}Ti_{0.01}Al_{0.01}(OH)₂ as nickel-titanium-aluminum hydroxide. LiOH was mixed with the precursor thus obtained at a molar ratio of 1.02, followed by calcination in an oxygen atmosphere at 730° C. for 30 hours.

### [Experimental Example 1]—Coin Half Cell Experiment

Each of the compounds synthesized in Comparative Examples and Examples as a cathode active material, Super-P as a conductive material, and PVdF as a binder were mixed at 95:2:3 (weight ratio) in N-methylpyrrolidone as a solvent to prepare a cathode active material slurry, and the cathode active material slurry was applied to an aluminum current collector, followed by drying at 120° C. and rolling to prepare a cathode.

An electrode assembly was prepared by using lithium metal as an anode in combination with the cathode prepared above and interposing a porous polyethylene film as a separator therebetween, after which the electrode assembly was placed inside a battery case and an electrolyte was injected into the battery case to fabricate a lithium secondary battery. The electrolyte used herein was a solution of 1.0M lithium hexafluorophosphate (LiPF₆) in an organic solvent consisting of ethylene carbonate/dimethyl carbonate (mix volume ratio of EC/DMC=1/1).

Each lithium secondary battery thus fabricated was subjected to 30 charge and discharge cycles at 45° C. under conditions of 0.1 C 4.3V (charge) and 0.1 C 3.0V (discharge), and 1.0 C 4.3V (charge) and 1.0 C 3.0V (discharge). The results are shown as Comparative Example 1 and Examples 1-1, 1-2, 2-1 and 2-2 in Table 1 below.

### [Experimental Example 2]—Pouch Full Cell Experiment

Each of the compounds synthesized in Comparative Example 1 and Examples 1-1 and 1-2 as a cathode active material, Super-P as a conductive material, and PVdF as a binder were mixed at 95:2:3 (weight ratio) in N-methylpyrrolidone as a solvent to prepare a cathode active material slurry, and the slurry was applied to an aluminum current collector, followed by drying at 120° C. and rolling to prepare a cathode.

An electrode assembly was prepared by using silicon/graphite (ratio of 20:80) as an anode active material for an anode in combination with the cathode prepared above such that the cathode/anode capacity ratio (N/P) was 1.1 and interposing a porous polyethylene film as a separator therebetween, after which the electrode assembly was placed inside a battery case and an electrolyte was injected into the battery case to fabricate a lithium secondary battery. The electrolyte used herein was a solution of 1.0M lithium hexafluorophosphate (LiPF₆) in an organic solvent consisting of ethylene carbonate/dimethyl carbonate/ethyl methyl carbonate (mix volume ratio of EC/DMC/EMC=1/2/1), and vinylene carbonate (VC 2 wt %).

Each lithium secondary battery thus fabricated was subjected to 30 charge and discharge cycles at 45° C. under conditions of 0.1 C 4.3V (charge) and 0.1 C 3.0V (discharge), and 1.0 C 4.3V (charge) and 1.0 C 3.0V (discharge). The results are shown as Comparative Experimental Example 1, Experimental Example 1, and Experimental Example 2 in Table 1 below.

TABLE 1

| | | Condition: 0.1 C/0.1 C | | | |
|---|---|---|---|---|---|
| | | 4.3 V | 3.0 V | Charge/ | |
| | | charge | discharge | discharge | 1 C/1 C |
| | | capacity | capacity | efficiency | 30^{th} cycle |
| Item | Type of cathode active material | (mAh/g) | (mAh/g) | (%) | (%) |
| Comparative | Ni_{0.82}Co_{0.11}Mn_{0.07} | 230.10 | 206.00 | 89.53 | 89.03 |
| Example 1 | | | | | |
| Example 1-1 | Ni_{0.94}Ti_{0.06} | 249.88 | 218.00 | 87.24 | 91.12 |
| Example 1-2 | Ni_{0.94}Ti_{0.04}Al_{0.02} | 246.40 | 215.44 | 87.44 | 92.50 |
| Example 2-1 | Ni_{0.94}Ti_{0.02} | 359.00 | 225.78 | 87.17 | 90.15 |
| Example 2-2 | Ni_{0.98}Ti_{0.01}Al_{0.01} | 255.94 | 223.17 | 87.20 | 91.08 |
| Comparative | Si-based anode + Ni_{0.82}Co_{0.11}Mn_{0.07} | 230.02 | 176.35 | 76.67 | 92.73 |
| Experimental | | | | | |
| Example 1 | | | | | |
| Experimental | Si-based anode + Ni_{0.94}Ti_{0.06} | 249.51 | 186.40 | 74.71 | 95.55 |
| Example 1 | | | | | |
| Experimental | Si-based anode + Ni_{0.94}Ti_{0.04}Al_{0.02} | 246.58 | 184.63 | 74.87 | 96.79 |
| Example 2 | | | | | |

As can be seen from Table 1, the cathode active materials (Examples 1-1 to 2-2) according to the present invention have higher charge capacity and lifespan characteristics and lower charge/discharge efficiency than the conventional cathode active material (Comparative Example 1).

In addition, it can be seen that when used in combination with the Si-based anode in Comparative Experimental Example 1 and Experimental Examples 1 and 2, the cathode active materials according to the present invention exhibit much higher lifespan characteristics and maintain almost the same charge capacity as the prior art.

Although preferred embodiments of the present invention have been disclosed for illustrative purposes, those skilled in the art will appreciate that various modifications, additions, and substitutions are possible without departing from the scope and spirit of the invention as disclosed in the accompanying claims.

1. A lithium composite metal oxide comprising nickel (Ni) and titanium (Ti) as main components.

2. The lithium composite metal oxide according to claim 1, wherein the lithium composite metal oxide simultaneously satisfies at least two characteristics among the following characteristics, measured based on a coin half cell:
a characteristic of a charge capacity of 235 mAh/g or more under conditions of 0.1 C 4.3V (charge) and 0.1 C 3.0V (discharge);
a characteristic of a charge/discharge efficiency of 90% or less under the conditions of 0.1 C 4.3V (charge) and 0.1 C 3.0V (discharge); and
a characteristic of a retention rate of a discharge capacity at a 30^{th} cycle with respect to a discharge capacity at a 1^{st} cycle, of 90% or more under conditions of 1.0 C 4.3V (charge) and 1.0 C 3.0V (discharge).

3. The lithium composite metal oxide according to claim 1, wherein the lithium composite metal oxide simultaneously satisfies at least two characteristics among the following characteristics, measured based on a pouch full cell to which a Si-based anode is applied:
a characteristic of a charge capacity of 235 mAh/g or more under the conditions of 0.1 C 4.3V (charge) and 0.1 C 3.0V (discharge);
a characteristic of a discharge capacity of 177 mAh/g or more under the conditions of 0.1 C 4.3V (charge) and 0.1 C 3.0V (discharge); and
a characteristic of a retention rate of a discharge capacity at a 30^{th} cycle with respect to a discharge capacity at a 1^{st} cycle, of 93% or more under conditions of 1.0 C 4.3V (charge) and 1.0 C 3.0V (discharge).

4. The lithium composite metal oxide according to claim 2, wherein the lithium composite metal oxide simultaneously satisfies all three characteristics.

5. The lithium composite metal oxide according to claim 1, wherein the lithium composite metal oxide comprises 82% or more of nickel and 0.5% or more of titanium.

6. The lithium composite metal oxide according to claim 1, wherein the lithium composite metal oxide does not comprise at least one of cobalt (Co) and manganese (Mn).

7. The lithium composite metal oxide according to claim 1, wherein when the lithium composite metal oxide further optionally comprises one or more of cobalt (Co) and manganese (Mn), a total content of cobalt and manganese is less than or equal to a content of titanium (Ti).

8. The lithium composite metal oxide according to claim 1, wherein the lithium composite metal oxide is represented by the following Formula 1:
Li[Li₁₋ₘXₘ]O₂ (1)
wherein
m satisfies 0<m≤1, and
X comprises only Ni and Ti.

9. The lithium composite metal oxide according to claim 1, wherein the lithium composite metal oxide is represented by the following Formula 2:
Li[Li_{1-a-b}NiₐTi_{b}]O₂ (2)
wherein
a and b satisfy 0<a<1, 0<b<1, a+b≤1 and a>b.

10. The lithium composite metal oxide according to claim 9, wherein
a and b satisfy 0.82≤a<1 and 0<b≤0.18.

11. The lithium composite metal oxide according to claim 1,
further comprising aluminum (Al) as another main component.

12. The lithium composite metal oxide according to claim 11,
wherein the lithium composite metal oxide is represented by Formula (3):
Li[Li_{1-a-b-c}NiₐTi_{b}Al_{c}]O₂ (3)
wherein
a, b and c satisfy 0<a<1, 0<b<1, and 0<c<1, with a proviso of a+b+c≤1, and a, b and c satisfy a>b≥c or a>c>b.

13. The lithium composite metal oxide according to claim 12, wherein a, b and c satisfy 0.82≤a<1, 0<b<0.18, and 0<c<0.18.

14. The lithium composite metal oxide according to claim 1, wherein the lithium composite metal oxide further comprises at least one of other dopant elements and optionally comprises aluminum (Al), and is represented by the following Formula 4:
Li[Li_{1-a-b-c-d}NiₐTi_{b}Al_{c}D_{d}]O₂ (4)
wherein
D includes at least one selected from the group consisting of Co, Mn, V, Cr, Fe, Cu, Zn, Y, Zr, Mo, W, Na, K, Rb, Cs, Fr, Be, Mg, Ca, Sr, Ba, Ra, B, Si, P, Sn, La and Ce,
a, b, c, and d satisfy 0<a<1, 0<b<1, 0≤c<1, 0≤d<1, and a+b+c+d≤1, and
a, b, c, and d satisfy a condition a>b≥c+d or a>c+d>b.

15. The lithium composite metal oxide according to claim 14, wherein a, b and c satisfy 0.82≤a<1, 0<b≤0.18, and 0≤c+d<0.18.

16. The lithium composite metal oxide according to claim 14, wherein at least one of Li, Ni, Ti, Al, and D has a concentration gradient that increases or decreases as a function of a radius of an oxide particle.

17. A cathode active material for a lithium secondary battery comprising the lithium composite metal oxide according to claim 1.

18. The cathode active material for a lithium secondary battery according to claim 17, wherein a coating layer is formed on a surface of a particle of the lithium composite metal oxide.

19. A lithium secondary battery comprising:
a cathode comprising the cathode active material according to claim 17;
an anode; and
an electrolyte.

20. The lithium secondary battery according to claim 19, wherein the anode comprises a Si-based anode active material.

21. The lithium secondary battery according to claim 20, wherein the Si-based anode active material comprises at least one selected from the group consisting of silicon (Si), silicon oxide, Si/A alloys, and Si/C composites.
